(19) United States
(12) Patent Application Publication
(10) Pub. No.: US 2026/0274066 A1
(43) Pub. Date: Sep. 17, 2026

(54) FUEL TANK ASSEMBLY FOR A VEHICLE

(71) Applicant: NISSAN NORTH AMERICA, INC., Franklin, TN (US)

(72) Inventors: Ryan Michael BARE, West Bloomfield, MI (US); David GRANT, Commerce, MI (US); Austin Grant PETTY, Waterford, MI (US)

(21) Appl. No.: 19/082,054

(22) Filed: Mar. 17, 2025

(51) Int. Cl. B60K 15/073; B60K 15/03

(52) U.S. Cl. CPC B60K 15/073; B60K 2015/03032

(57) ABSTRACT

A fuel tank assembly for a vehicle includes a fuel tank and a first stop member. The fuel tank is configured to store fuel. The fuel tank has a front surface configured to face a forward direction of the vehicle, a rear surface configured to face a rearward direction of the vehicle, and an upper surface extending between the front and rear surfaces. The first stop member extends upwardly from the upper surface of the fuel tank. The first stop member is configured to contact a body cross member in an installation state in which the fuel tank assembly is installed to the vehicle to substantially prevent movement of the fuel tank.

### BACKGROUND

### Field of the Invention

The present invention generally relates to fuel tank assembly for a vehicle. More specifically, the present invention relates to a fuel tank having a stop member to substantially prevent movement of the fuel tank.

### Background Information

A vehicle fuel tank is conventionally mounted to a vehicle frame with mounting straps and brackets. The mounting straps and brackets allow rearward movement of the vehicle fuel tank after installation of the fuel tank to the vehicle.

### SUMMARY

An object of the disclosure is to provide a stop member to substantially prevent movement of a vehicle fuel tank.

In view of the state of the known technology, one aspect of the present disclosure is to provide a fuel tank assembly for a vehicle including a fuel tank and a first stop member. The fuel tank is configured to store fuel. The fuel tank has a front surface configured to face a forward direction of the vehicle, a rear surface configured to face a rearward direction of the vehicle, and an upper surface extending between the front and rear surfaces. The first stop member extends upwardly from the upper surface of the fuel tank. The first stop member is configured to contact a body cross member in an installation state in which the fuel tank assembly is installed to the vehicle to substantially prevent movement of the fuel tank.

Another aspect of the present disclosure is to provide a vehicle fuel tank assembly. The vehicle fuel tank assembly includes a vehicle body structure, a body cross member, a fuel tank, and a first stop member. The body cross member is connected to the vehicle body structure. The fuel tank is connected to the vehicle body structure. The fuel tank has a front surface facing a forward direction of the vehicle, a rear surface facing a rearward direction of a vehicle, and an upper surface extending between the front and rear surfaces. The first stop member extends upwardly from the upper surface of the fuel tank. The first stop member is configured to contact the body cross member to substantially prevent movement of the fuel tank in the rearward direction.

Also other objects, features, aspects and advantages of the disclosed fuel tank assembly for a vehicle will become apparent to those skilled in the art from the following detailed description, which, taken in conjunction with the annexed drawings, discloses exemplary embodiments of the fuel tank assembly for a vehicle.

### BRIEF DESCRIPTION OF THE DRAWINGS

Referring now to the attached drawings which form a part of this original disclosure:

FIG. 1 is a perspective view of a fuel tank assembly for a vehicle in accordance with an exemplary embodiment;

FIG. 2 is a perspective view of the fuel tank assembly of FIG. 1 in which a stop member contacts a vehicle body cross member;

FIG. 3 is a side elevational view of the fuel tank assembly of FIG. 1;

FIG. 4 is a side elevational view of a vehicle fuel tank assembly of FIG. 1 connected to a vehicle body structure;

FIG. 5 is an enlarged side elevational view of the stop member of the fuel tank assembly of FIG. 4;

FIG. 6 is a perspective view of the fuel tank assembly of FIG. 1 including mounting straps;

FIG. 7 is a front perspective view of the fuel tank assembly of FIG. 1 illustrating grooves configured to receive the mounting straps;

FIG. 8 is a perspective view of a vehicle body structure including a body cross member;

FIG. 9 is a perspective view of a fuel tank assembly in accordance with another exemplary embodiment; and

FIG. 10 is a side elevational view of the fuel tank assembly of FIG. 9.

### DETAILED DESCRIPTION OF EXEMPLARY EMBODIMENTS

Selected embodiments will now be explained with reference to the drawings. It will be apparent to those skilled in the art from this disclosure that the following descriptions of the exemplary embodiments are provided for illustration only and not for the purpose of limiting the invention as defined by the appended claims and their equivalents.

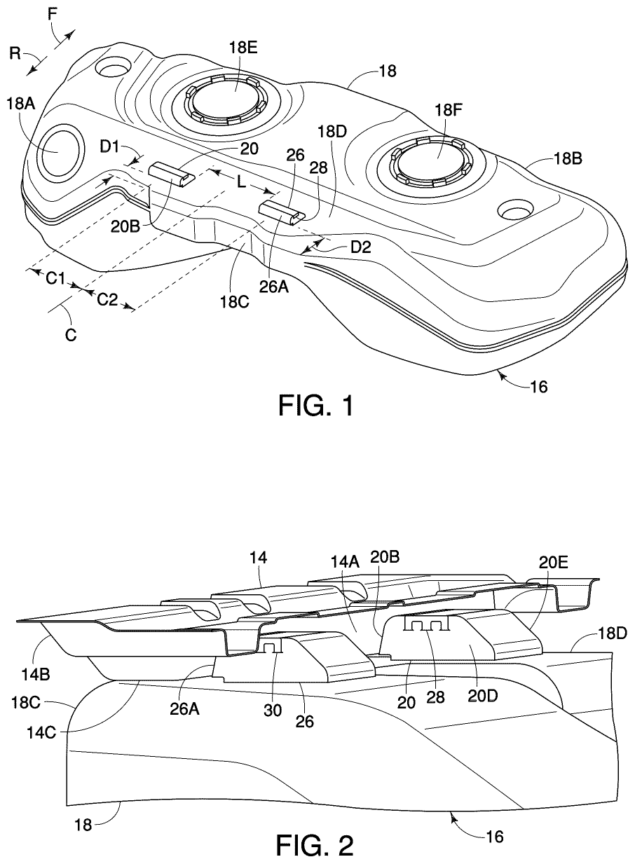

Referring initially to FIG. 1-8, a vehicle fuel tank assembly 10 is illustrated in accordance with an exemplary embodiment. The vehicle fuel tank assembly 10 includes a vehicle body structure 12, a body cross member 14 connected to the vehicle body structure 12, and a fuel tank assembly 16 connected to the vehicle body structure 12. The fuel tank assembly 16 includes a fuel tank 18 and a first stop member 20 extending upwardly from an upper surface 18A of the fuel tank 18.

The vehicle includes the vehicle body structure 12, as shown in FIGS. 4, 5 and 8. The vehicle body structure 12 includes a floor panel 22. The rear body cross member 14 is connected to the floor panel 22 in any suitable manner. The body cross member 14 extends in a lateral, or width, direction of the vehicle. The body cross member 14 protrudes downwardly from the floor panel 22. A first opening 22A and a second opening 22B are formed in the floor panel 22, as shown in FIG. 8. The first opening 22A is configured to provide access to a fuel pump assembly disposed in the fuel tank 18. The second opening 22B is configured to provide access to a fuel tank level sending assembly disposed in the fuel tank 18.

The body cross member 14 has a first, or forward facing, surface 14A facing a vehicle forward direction F, as shown in FIGS. 2, 5 and 8. The body cross member 14 has a second, or rearward facing, surface 14B facing a vehicle rearward direction R. A third surface 14C of the body cross member 14 faces downwardly and connects the first and second surfaces 14A and 14B of the body cross member 14.

The fuel tank 18 is configured to store fuel supplied to the fuel tank through an inlet pipe, or fuel filler neck, connected to an inlet 18A of the fuel tank. The fuel tank 18 is connected to the floor panel 22 of the vehicle body structure 12. As shown in FIGS. 1 and 4, the fuel tank 18 has a front, or first, surface 18B configured to face in the vehicle forward direction F and a rear, or second, surface 18C configured to face in the vehicle rearward direction R. An upper surface 18D extends between the front surface 18B and the rear surface 18C. The fuel tank 18 is preferably made of a plastic material, such as high-density polyethylene.

A fuel pump opening 18E and a gauge opening 18F are disposed in the upper surface 18D of the fuel tank 18, as shown in FIGS. 1 and 4. The fuel pump opening 18E is configured to receive a fuel pump assembly, which is configured to supply fuel from the fuel tank 18 to the engine. The gauge opening 18F is configured to receive the fuel tank level sending assembly, which is configured to indicate a fuel level of the fuel tank 18. When the fuel tank 18 is installed to the vehicle, as shown in FIG. 4, the fuel pump opening 18E is aligned with the first opening 22A in the floor panel 22, and the gauge opening 18F is aligned with the second opening 22B in the floor panel 22, such that the interior of the fuel tank 18 is accessible through the floor panel 22.

The first stop member 20 extends upwardly from the upper surface 18D of the fuel tank 18, as shown in FIG. 1-7. The first stop member 20 is configured to engage the body cross member 14 to substantially prevent movement of the fuel tank 18 in the rearward direction R. The first stop member 20 is preferably made of the same plastic material as the fuel tank 18. The first stop member 20 is preferably hot plate welded to the fuel tank 18 to securely fix the first stop member 20 to the fuel tank 18. A weld bead 24 is formed around the perimeter of the first stop member 20 when the first stop member 20 is hot plate welded to the fuel tank 18. A recess 20A can be formed in the rearward facing surface 20B of the first stop member 20 such that contact between the first stop member 20 and the body cross member 14 does not interfere with the weld bead 24.

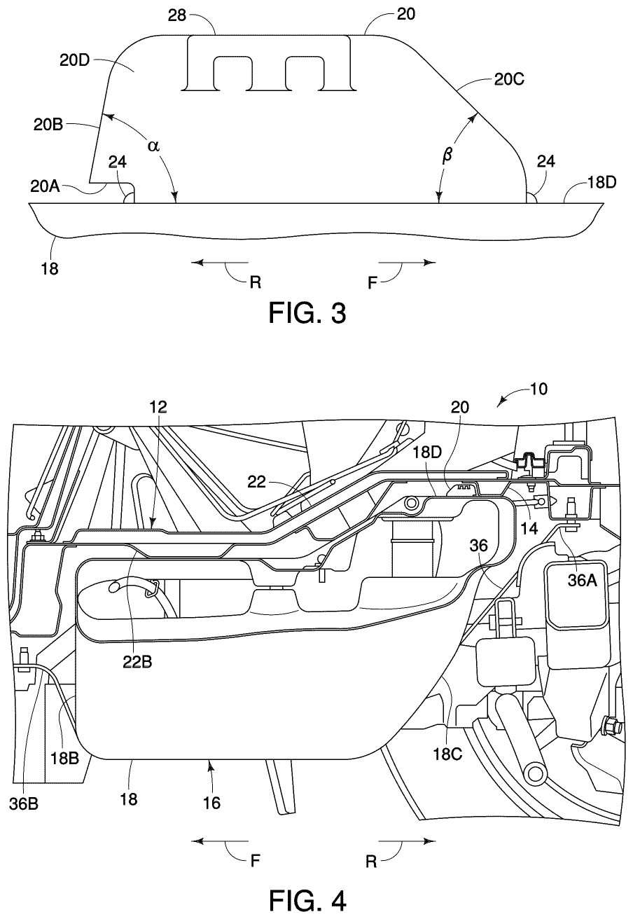

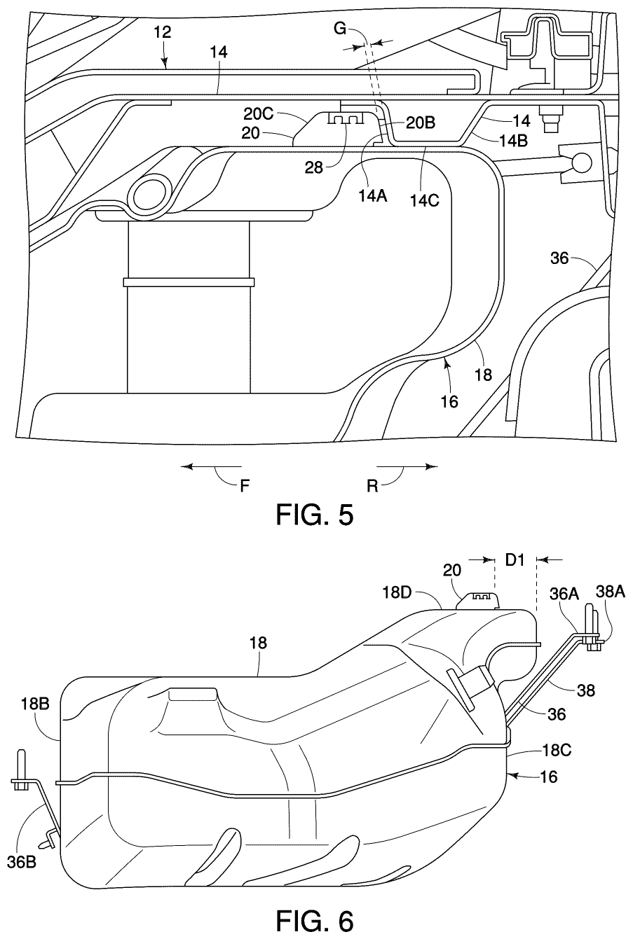

The first stop member 20 has a forward facing, or first, surface 20C and a rearward facing, or second, surface 20B, as shown in FIG. 3. The forward facing surface 20C faces in the vehicle forward direction F. The rearward facing surface 20B faces in the vehicle rearward direction R. The forward facing surface 20C is angled to reduce material of the first stop member 20, while increasing a size of the weld surface. The rearward facing surface 20B preferably has an angle and radius substantially corresponding to the first surface 14A of the body cross member 14, as shown in FIG. 5. As shown in FIG. 3, an angle α is defined between the rearward facing surface 20B of the first stop member 20 and the upper surface 18D of the fuel tank 18. An angle β is defined between the forward facing surface 20C of the first stop member 20 and the upper surface 18D of the fuel tank 18. The angle α is preferably larger than angle β, as shown in FIG. 3. In other words, the angle α is closer to 90 degrees than the angle β.

A second stop member 26 extends upwardly from the upper surface 18D of the fuel tank 18, as shown in FIG. 1-4. The second stop member 26 is configured to engage the body cross member 14 to substantially prevent movement of the fuel tank 18 in the vehicle rearward direction R. The second stop member 26 is preferably substantially identically configured as the first stop member 20. Although the fuel tank 18 is shown having a first stop member 20 and a second stop member 26, the fuel tank 18 can have any suitable number of stop members, such as one stop member or more than two stop members. Increasing the number of stop members facilitates distributing a contact force with the body cross member 14 to each of the stop members, which prevents damaging the stop members.

The second stop member 26 is spaced from the first stop member 20 in the lateral direction of the vehicle, as shown in FIG. 1. The second stop member 26 is spaced from the first stop member 20 by a distance L in the lateral direction of the vehicle. The distance L can be any suitable distance in which the first and second stop members are configured to contact the body cross member 14 to prevent movement of the fuel tank 18 in the vehicle rearward direction R.

A first distance D1 between the rearward surface 18C of the fuel tank 18 and the rearward facing surface 20B of the first stop member 20 is substantially similar to a second distance D2 between the rearward surface 18C of the fuel tank 18 and the rearward facing surface 26A of the second stop member 26, as shown in FIGS. 1 and 6.

The first stop member 20 can include an overhang portion 28, as shown in FIG. 1-7. The overhang portion 28 overhangs first and second side surfaces 20D and 20E of the first stop member 20. In other words, a distance between the ends of the overhang portion 28 in the lateral direction is longer than a distance between the first and second side surfaces 20D and 20E of the first stop member 20 in the lateral direction. The overhang portion 28 is preferably integrally formed with the first stop member 20, although the overhang portion 28 can be formed in any suitable manner. The overhang portion 28 facilitates installation of the first stop member 20 to the fuel tank 18, such that a robotic arm can pick up the first stop member 20 by the overhang portion 28 and position the first stop member 20 on the fuel tank 18. The second stop member 26 can have a similarly configured overhang portion 30.

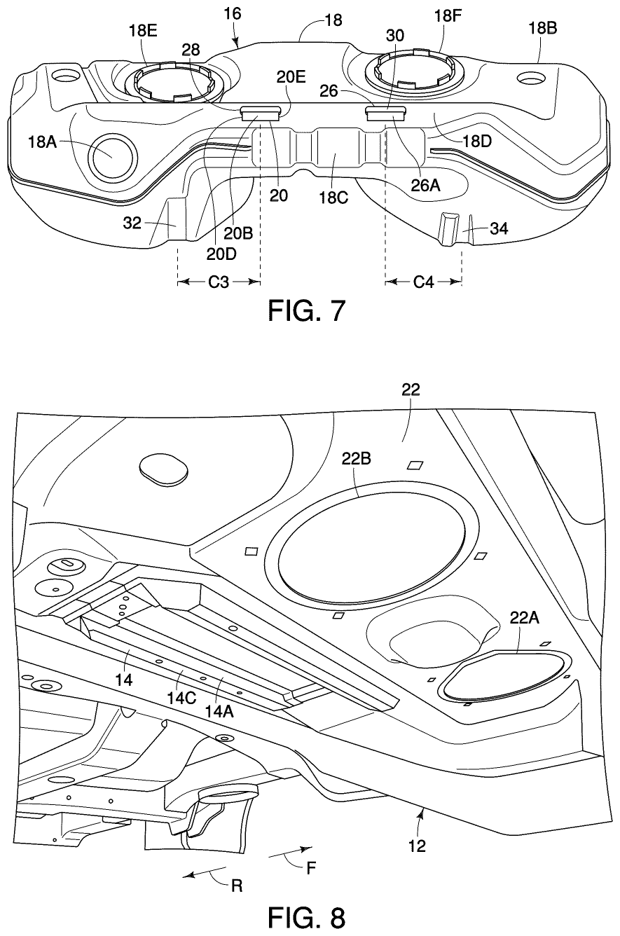

A first groove 32 is formed in the front surface 18C of the fuel tank 18, as shown in FIG. 7. A second groove 34 is formed in the front surface 18C of the fuel tank 18. The first and second grooves 32 and 34 are configured to receive first and second straps 36 and 38, respectively, to secure the fuel tank assembly 16 to the vehicle body structure 12, as shown in FIGS. 4 and 6. As shown in FIG. 7, the first and second stop members 20 and 26 are disposed between the first and second grooves 32 and 34 in the lateral direction of the vehicle. In other words, the first groove 32 is disposed in a vehicle outboard direction from the first stop member 20, and the second groove 34 is disposed in the vehicle outboard direction from the second stop member 26.

The first strap 36 has a first end 36A and a second end 36B, as shown in FIGS. 4 and 6. The first end 36A of the first strap 36 is connected to the vehicle body structure 12 rearward of the rear surface 18C of the fuel tank 18. The second end 36B of the first strap 36 is connected to the vehicle body structure forward of the forward surface 18B of the fuel tank 18. The first end 38A of the second strap 38 is connected to the vehicle body structure 12 rearward of the rear surface 18C of the fuel tank 18. The second end 38B of the second strap 38 is connected to the vehicle body structure 12 forward of the forward surface 18B of the fuel tank 18. The first and second straps 36 and 38 secure the fuel tank assembly 16 to the vehicle body structure 12 in an installation position.

First and second distances C1 and C2 from a center C of the fuel tank 18 to a center of each of the first and second stop members 20 and 26 in the lateral direction are preferably substantially equal, as shown in FIG. 1. Preferably, a third distance C3 from a center of the first strap 36 to a center of the first stop member 20 in the lateral direction is substantially equal to a fourth distance C4 from a center of the second strap 38 to a center of the second stop member 26, as shown in FIG. 7. Providing the distances C1 and C2 being substantially equal and providing the distances C3 and C4 being substantially equal for the first and second stop members 20 and 26 substantially prevents rotation of the fuel tank 18 after installation.

To assemble the fuel tank assembly 16, the first and second stop members 20 and 26 are connected to the upper surface 18D of the fuel tank 18 by any suitable method, such as by hot plate welding, as shown in FIGS. 1, 3, 6 and 7. The fuel tank assembly 16 is then connected to the vehicle body structure 12 by the first and second straps 34 and 36, as shown in FIG. 4-6 and 8.

In the installation position, the first stop member 20 can either contact the body cross member 14 or be spaced from the body cross member 14 by a gap G of a predetermined tolerance, as shown in FIG. 5. The predetermined tolerance is −1.0 mm/+5.0 mm from nominal. The nominal position is the rear face 20B of the first stop member 20 contacting the first surface 14A of the body cross member 14, such that the gap G is not formed between the rearward facing surface 20B of the first stop member 20 and the first surface 14A of the body cross member 14. In other words, the tank 18 can be pushed forward (i.e., in the forward direction F) by the body cross member 14 by 1.0 mm (i.e., the −1.0 mm tolerance) to a gap G of 5.0 mm between the tank 18 and the body cross member 14 (i.e., the +5.0 mm tolerance). The first stop member 20 is configured to contact the body cross member 14 to prevent movement of the fuel tank 18 in the rearward direction R. In an installation position in which the first stop member 20 and the body cross member 14 contact one another (i.e., there is no gap G), the contact prevents rearward movement of the fuel tank 18. In an installation position in which the rear face 20B of the first stop member 20 is spaced by the gap G from the first surface 14A of the body cross member 14, the fuel tank 18 moves rearward by an amount of the gap G and contacts the body cross member 14 to prevent further rearward movement of the fuel tank 18 in the rearward direction R. In other words, the rearward facing surface 20B of the first stop member 20 is configured to contact the first surface 14A of the body cross member 14 in the installation state to substantially prevent rearward movement of the fuel tank 18.

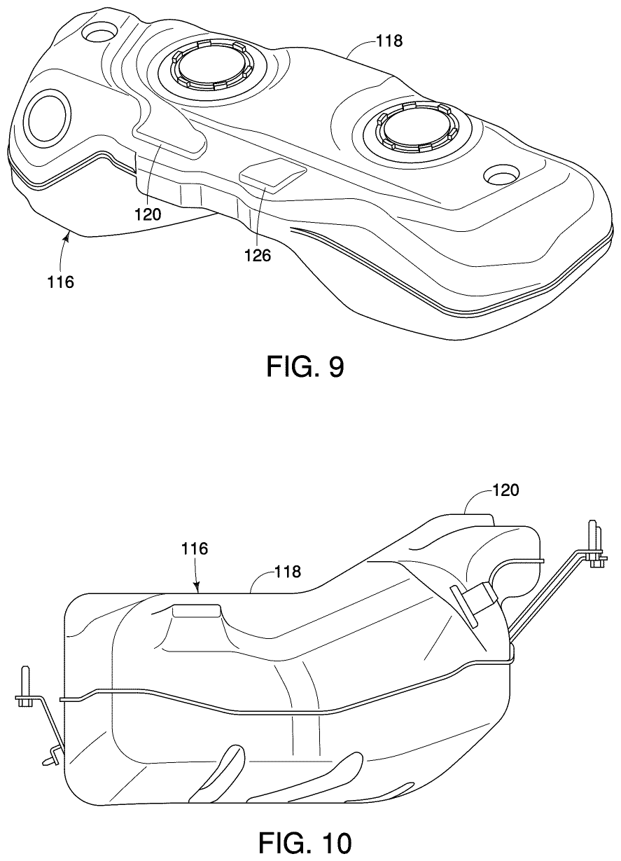

As shown in FIGS. 9 and 10, a fuel tank assembly 116 in accordance with another illustrated exemplary embodiment is substantially similar to the fuel tank assembly 16 of the exemplary embodiment illustrated in FIG. 1-8 except for the differences described below. Similar parts are identified with similar reference numerals, except increased by 100 (i.e., 1xx, accordingly).

The fuel tank assembly 116 includes a fuel tank 118, a first stop member 120 and a second stop member 126, as shown in FIGS. 9 and 10. The first stop member 120 is integrally formed with the fuel tank 118 as a one piece member by flow molding. The second stop member 126 is integrally formed with the fuel tank 118 as a one-piece member by blow molding. The configurations of the fuel tank 118, the first stop member 120 and the second stop member 126 are substantially similar to the configurations of the fuel tank 18, the first stop member 120 and the second stop member 126 illustrated in FIG. 1-8.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the vehicle fuel tank assembly. Accordingly, these terms, as utilized to describe the present invention should be interpreted relative to a vehicle equipped with the vehicle fuel tank assembly.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the exemplary embodiments according to the present invention are provided for illustration only, and not for the purpose of limiting the invention as defined by the appended claims and their equivalents.

What is claimed is:

1. A fuel tank assembly for a vehicle, the fuel tank assembly comprising:
a fuel tank configured to store fuel, the fuel tank having a front surface configured to face a forward direction of the vehicle, a rear surface configured to face a rearward direction of the vehicle, and an upper surface extending between the front and rear surfaces; and
a first stop member extending upwardly from the upper surface of the fuel tank, the first stop member being configured to contact a body cross member in an installation state in which the fuel tank assembly is installed to the vehicle to substantially prevent movement of the fuel tank.

2. The fuel tank assembly according to claim 1, wherein
the first stop member has a rearward facing surface, the rearward facing surface being configured to contact the body cross member in the installation state.

3. The fuel tank assembly according to claim 1, wherein
the fuel tank is made of a plastic material, and the first stop member is made of the same plastic material.

4. The fuel tank assembly according to claim 3, wherein
the first stop member is hot plate welded to the fuel tank.

5. The fuel tank assembly according to claim 1, wherein
the first stop member is integrally formed with the fuel tank as a one-piece member by blow molding.

6. The fuel tank assembly according to claim 1, wherein
a second stop member extends upwardly from the upper surface of the fuel tank, the second stop member being configured to contact the body cross member in the installation state to substantially prevent movement of the fuel tank.

7. The fuel tank assembly according to claim 6, wherein
the second stop member is spaced from the first stop member in a lateral direction of the vehicle.

8. The fuel tank assembly according to claim 6, wherein
a first distance between the rearward surface of the fuel tank and a rearward facing surface of the first stop member is substantially equal to a second distance between the rearward surface of the fuel tank and a rearward facing surface of the second stop member.

9. The fuel tank assembly according to claim 3, wherein
a first groove is formed in the front surface of the fuel tank, and a second groove is formed in the front surface of the tank, the first groove being configured to receive a first strap and the second groove being configured to receive a second strap in the installation position to secure the fuel tank to a vehicle body structure.

10. The fuel tank assembly according to claim 9, wherein
the first and second stop members are disposed between the first and second grooves in a lateral direction of the vehicle.

11. A vehicle fuel tank assembly, comprising:
a vehicle body structure;
a body cross member connected to the vehicle body structure;
a fuel tank connected to the vehicle body structure, the fuel tank having a front surface facing a forward direction of the vehicle, a rear surface facing a rearward direction of a vehicle, and an upper surface extending between the front and rear surfaces; and
a first stop member extending upwardly from the upper surface of the fuel tank, the first stop member being configured to contact the body cross member to substantially prevent movement of the fuel tank in the rearward direction.

12. The vehicle fuel tank assembly according to claim 11, wherein
the first stop member has a rearward facing surface, the rearward facing surface being configured to contact the body cross member.

13. The vehicle fuel tank assembly according to claim 11, wherein
a second stop member extends upwardly from the upper surface of the fuel tank, the second stop member being configured to contact the body cross member.

14. The vehicle fuel tank assembly according to claim 13, wherein
the second stop member is spaced from the first stop member in a lateral direction of the vehicle.

15. The vehicle fuel tank assembly according to claim 13, wherein
a first distance between the rearward surface of the fuel tank and a rearward facing surface of the first stop member is substantially equal to a second distance between the rearward surface of the fuel tank and a rearward facing surface of the second stop member.

16. The vehicle fuel tank assembly according to claim 13, wherein
a first groove is formed in the front surface of the fuel tank;
a second groove is formed in the front surface of the tank;
a first strap is received by the first groove; and
a second strap is received by the second groove,
first and second ends of the first strap and the second strap being connected to the vehicle body structure.

17. The vehicle fuel tank assembly according to claim 16, wherein
the first and second stop members are disposed between the first and second grooves in a lateral direction of the vehicle.

18. The vehicle fuel tank assembly according to claim 11, wherein
the fuel tank is made of a plastic material, and the first stop member is made of the same plastic material.

19. The vehicle fuel tank assembly according to claim 18, wherein
the first stop member is hot plate welded to the fuel tank.

20. The vehicle fuel tank assembly according to claim 11, wherein
the first stop member is integrally formed with the fuel tank as a one-piece member by blow molding.
